(19) United States
(12) Patent Application Publication
(10) Pub. No.: US 2011/0070015 A1
(43) Pub. Date: Mar. 24, 2011

(54) MOP HEAD AND METHOD OF MOPPING

(75) Inventor: Peter Teerlink, Rotterdam (NL)

(73) Assignee: INNOCLEANING MAGMA HOLDING B.V., Capelle Aan Den IJssel (NL)

(21) Appl. No.: 12/668,221

(22) PCT Filed: Jul. 9, 2007
(86) PCT No.: PCT/NL07/50338

§ 371 Date: Nov. 19, 2010

(51) Int. Cl. B43M 11/06

(52) U.S. Cl. 401/263

(57) ABSTRACT

Mop head (1), provided with nozzles (4) for dispensing fluid to a surface and a mop face (2) that is to be passed along that surface, wherein the mop head (1) is provided with a fluid guide (5) for guiding fluid to the nozzles (4), and the mop face (2) comprises a mid face (7) and opposite end faces (8), wherein at least one end face (8) is arranged to extend at an angle with respect to the mid face (7), wherein the angle between the mid face (7) and the at least one end face (8) is larger than 180°.

Mop head, provided with nozzles for dispensing fluid to a surface, a fluid guide for guiding fluid to the nozzles, and a mop face that is to be passed along the surface

Moreover, the invention is related to a method of mopping.

Most conventional mops having fluid dispensing nozzles, such as steam nozzles, are provided with a flat mop face to which a cleaning fabric is connected. The dispensing of fluid such as steam to the floor will aid in providing for better and/or easier cleaning of the floor, at least as compared to mopping without dispensing fluid. However, the inherently rigid construction, the sometimes relatively heavy weight, and the arrangement of the fluid canals of these mop heads limit the use of such mops to substantially straight and horizontal surfaces, e.g. floors.

In a first aspect, the invention comprises a mop head, provided with nozzles for dispensing fluid to a surface, a fluid guide for guiding fluid to the nozzles, and a mop face that is to be passed along the surface, wherein the mop face comprises a mid face and opposite end faces, wherein at least one end face is arranged to extend at an angle with respect to the mid face, wherein the angle between the mid face and the at least one end face is larger than 180°.

The mop head according to the invention now allows for mopping and/or dispensing fluids to second surfaces, e.g. a wall or base board, that are at an angle, e.g. 90°, with respect to a first surface, e.g. a floor, by passing at least one end face of the mop head along the second surface. These second surfaces may be mopped at the same time as the first surface using the same mop. For example the floor is cleaned with the mid face and one end face, while a part of a wall and/or base board is cleaned with another end face of the mop. Thanks to the invention parts of a wall, base board or ramp can be mopped and at the same time fluid, particularly steam may be dispensed thereto, while mopping the floor.

Preferably, the nozzles and/or the fluid guide are arranged to dispense fluid to said second surface, for example the nozzles are provided along or in the at least one end face for cleaning the second surface, or at least the nozzles are arranged such that fluid is dispensed to said second surface. Preferably, the fluid guide extends through and/or a pivoting axis, e.g. a hinge, that permits the pivoting of the end faces with respect to the mid face about a pivot axis.

In a second aspect, the invention comprises a method of mopping, wherein by means of a mop a first surface is mopped and a fluid is dispensed to said first surface, wherein at the same time a second surface is mopped, that is at an angle of larger than 180° with the first surface, and a fluid is dispensed to said second surface using the same mop.

In clarification of the invention, these and further embodiments of the invention, and advantages thereof will be further elucidated with reference to the drawing. In the drawing:

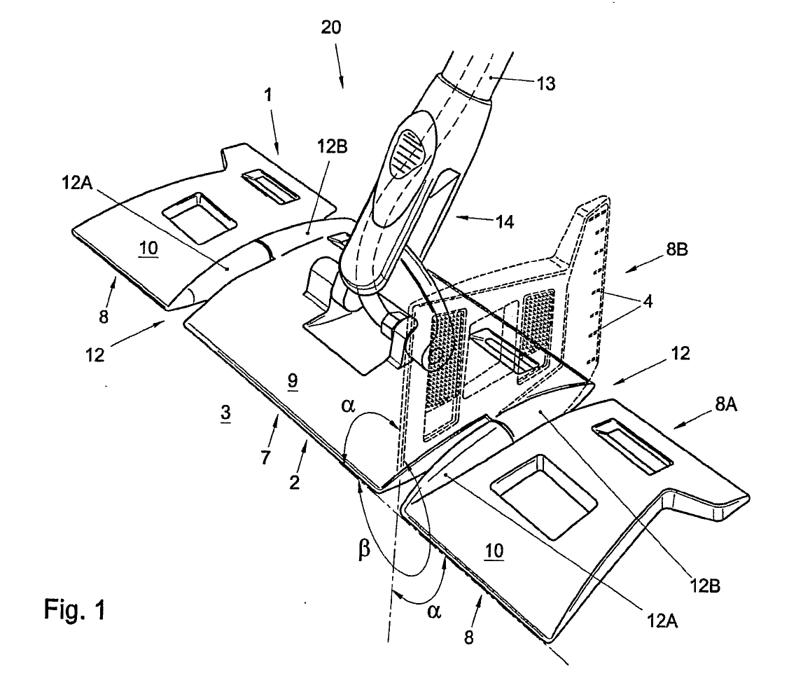

FIG. 1 is a perspective view of a mop head;

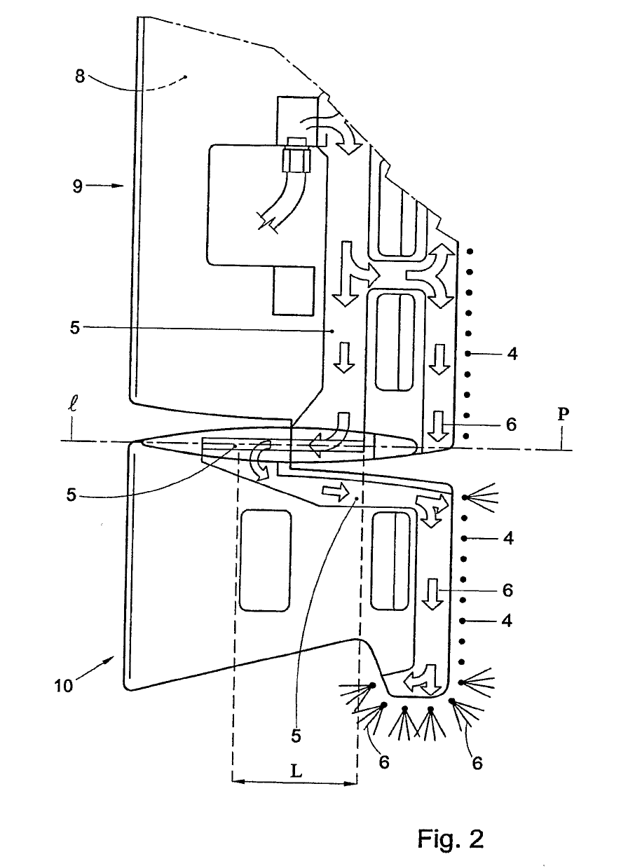

FIG. 2 is a sectional top view of a mop head;

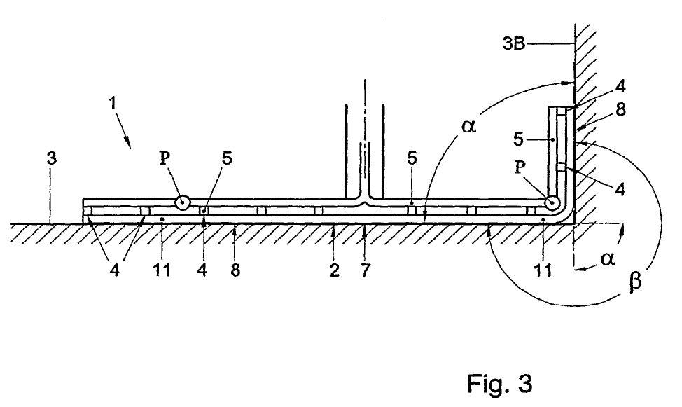

FIG. 3 is a sectional front view of a mop head simultaneously cleaning two surfaces;

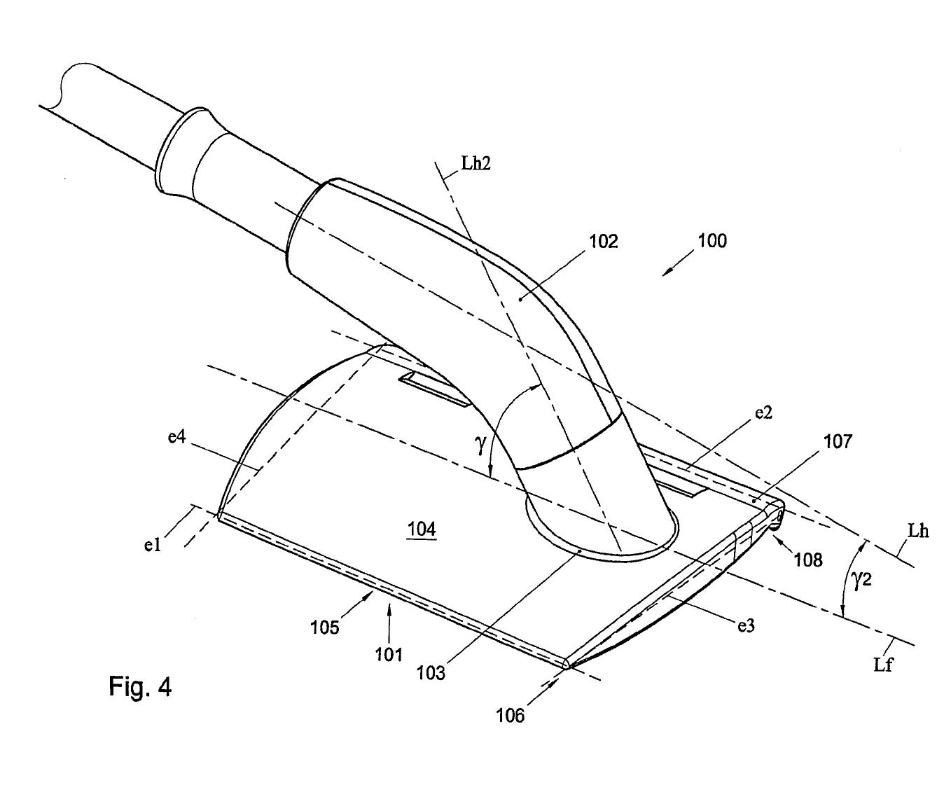

FIG. 4 is a perspective view of a steam cleaning tool;

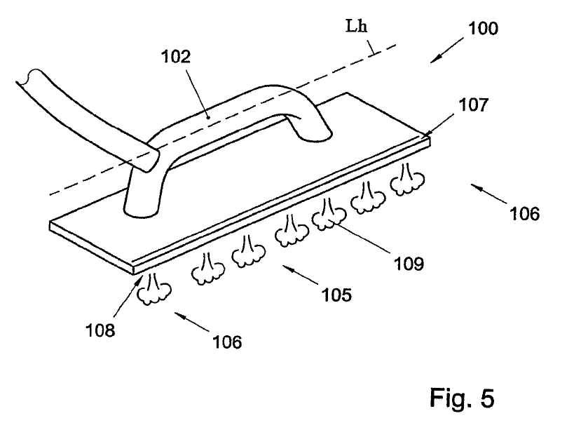

FIG. 5 is a perspective view of a steam cleaning tool.

In this description, identical or corresponding parts have identical or corresponding reference numerals. The exemplary embodiments shown should not be construed to be limitative in any manner and serve merely as illustration.

FIG. 1 shows a part of a mop 20 having a mop head 1, provided with a mop face 2, lying flat on a first surface 3. Nozzles 4 are provided in the mop face 2 for dispensing fluid 6, e.g. steam, to the first surface 3. Preferably, the nozzles 4 are provided near and/or along a side of the mop face 2, for example near the edge of the mop face 2, and/or in a separate profile that extends along the mop face 2. A cleaning fabric 11 may be connected to the mop face 2. A fluid guide 5 for guiding fluid 6 to the nozzles 4 is provided within the mop head 1, as shown in part in the sectional top view of FIG. 2. The mop face 3 comprises a mid face 7 and opposite end faces 8, being part of a mid section 9 and opposite end sections 10, respectively.

In FIG. 1 one of the end faces 8 is shown in a flat position 8A as well as a pivoted position 8B such that it faces a second surface that is under an angle α with the first surface 3. The end faces 8 are arranged to extend at an angle β of 180°, or larger, i.e. 270°, with respect to the mid face 7. As shown in FIG. 1, the angle β between the mid face 7 and the at least one end face 8 can be approximately 270°, such that the end face 8 can be used to mop a second surface that is under an angle α, e.g. of approximately 90°, with respect to the first surface 3. The nozzles 4 are provided in and/or near the mid face 7 as well as the end faces 8, such that nozzles 4 extending in and/or along the end face 8 may also be at an angle β of approximately 270° with respect to nozzles 4 extending in and/or along the mid face 7.

In FIG. 3 it is schematically illustrated that by means of the mop 20 a first surface 3 is mopped while a fluid 6 is dispensed through nozzles 4 and at the same time a second surface 3B is mopped, that is at an angle α with the first surface 3, while fluid 6 is dispensed to said second surface 3B using the same mop 20. Said fluid 6 preferably comprises steam delivered by a fluid supply, not shown, connected to the fluid guide(s) 5. With the embodiment shown, a second surface 3B can be cleaned while applying fluid and preferably steam to that second surface 3B. For example, the first surface 3 may be a floor while the second surface 3B may be a wall and/or a base board, for example. The end face 8 is arranged to pivot with respect to the mid face 7 about a pivoting axis P and about an angle α of preferably at least 90° for cleaning both surfaces 3, 3B at the same time. Preferably, the cleaning fabric 11 is connected to the mop face 2 when cleaning the surfaces 3, 3B.

In an embodiment a part of the fluid guide 5 extends substantially parallel to a pivoting axis P of the mid 7 and end face 8, for a certain length L (see FIG. 2), i.e. the longitudinal axis 1 of said part of the fluid guide 5 is approximately parallel or equal to the pivoting axis P. When, in this embodiment, the end face 8 is pivoted with respect to the mid face 7 a part of the fluid guide 5 is turned about the pivoting axis P, without being bended in a disadvantageous manner. By having a part of the fluid guide 5 extending parallel to the pivoting axis P, it can be prevented that the guide 5 is bended too much or too many times, and damages.

As can be seen from FIG. 1, the mop head 1 may comprise first hinges 12 that are arranged to pivot the mid face 7 and the end faces 8 with respect to each other about pivot axis P. In an embodiment the fluid guide 5 is guided through these first hinges 12. The fluid guide 5 may for example comprise a tube 5A, wherein the tube 5A is guided through the first hinges 12. By guiding the guide 5 through the first hinge 12, the guide 5 may be protected by the housing of the first hinge 12. Moreover it is possible to pivot the end face 8 without bending the guide 5. In an embodiment, the first hinge 12 has two connecting parts 12A, 12B that hinge with respect to each other around pivot axis P and preferably about the longitudinal axis 1 of the part of the fluid guide 5 that extends through said hinge 12. The fluid guide 5 may extend from a fluid supply connected to the mop 20, through a handle 13 of the mop 20, through a second hinge 14, from the mid section 9 to the at least one end section 10 to guide fluid 6 to the nozzles 4 of the mid face 7 and the end faces 8.

In different embodiments, different mechanisms can be used to provide for a hinging connection between the mid face 7 and the end faces 8. For example, living hinges can be used, flexible strips, bending material, etc.

Preferably, the mop head 1 is provided with at least one connection element 15 for cleaning fabric 11, which connection element 15 is arranged to move along the mop face 2. The connection elements 15 may comprise sliding elements arranged to slide along the mop face 2. The movable connection elements 15 may be provided in the mid face 7 and/or the end faces 8, preferably at least in the end faces 8. When the end faces 8 are pivoted, the cleaning fabric 11 will tighten and at least partly move along the mop face 2. By connection to the mop face 2 via the slidable, or at least movable, connection elements 15, it will be possible to have the fabric 11 stay in relatively stable connection with the mop face 2 while a part of the fabric 11 slides along at least a part of the mop face 2. In an embodiment a connection element 15 comprises Velcro for easy connection to the cleaning fabric 11.

An alternative embodiment of a mop head 1 for example comprises a fixed end face 8 that is arranged to fixedly extend at angle β. The end face 8 may for example be fixed in an angled position with respect to the mid face 7, e.g. having an angle β of 270°, without pivoting. Second surfaces 3B that are at an angle α with respect to the first surface 3 can be mopped with the end face 8.

In FIG. 4 an embodiment of a mop head is shown, which will be referred to as a steam cleaning tool 100, which mop head/steam cleaning tool 100 may be regarded as a separate invention, apart from the mop head 1. The steam cleaning tool is particularly optimised for cleaning relatively soft and rough surfaces such as mattresses, pillows and/or cushions. The steam cleaning tool 100 may for example form an exchangeable element to be fitted to a steam supply and can for example be exchanged with the mop head 1, to fit to the same steam supply.

In an embodiment, the tool 100 is provided with a cleaning face (i.e. mop face) 101, nozzles 108 that are provided in and/or along the cleaning face 101, and a fluid guide for guiding fluid to the nozzles 108. The tool 100 is provided with a handgrip 102 that is connected directly to, or at least close to the cleaning face 101, at the opposite side of the nozzles 108. A steam or fluid supply may be connected to the handgrip 102. Preferably, the longitudinal edges e1, e2 of the cleaning face 101 are longer than its transversal edges e3, e4, whereas the handgrip 102 extends in a direction approximately parallel to and/or between the longitudinal edges e1, e2, at least seen from a direction perpendicular to the cleaning face 101. The handgrip 102 has a connection 103 to the cleaning face 101, or at least to a housing 104 or frame of the cleaning tool 100, which connection 103 preferably is located near a longitudinal end section 106, or at least between a mid section 105 and the longitudinal end section 106 of the cleaning face 101.

In an embodiment, for comfort of use a longitudinal axis Lh of a part of the handgrip 102 may extend at a second angle γ2, which is near to 0°, for example between 0 and 45°, preferably between 0° and 30°, with respect to the longitudinal axis Lf of the cleaning face 101. A second longitudinal axis Lh2 of the handgrip 102 extends under an angle γ with respect to a longitudinal axis Lf of the cleaning face 101 of between 20° and 70° near said connection 103.

In a preferred embodiment of the steam cleaning tool 100, the nozzles 108 of the tool 100 are arranged near and/or along at least one of the longitudinal edges e1, e2 of the cleaning face 101. For example, the nozzles 108 are arranged in a profile 107 along a longitudinal edge e1 of the cleaning face 101.

In a relatively easy-to-use embodiment, the connection 103 between the handgrip 102 and the cleaning face 101, or at least the housing 104 thereof, is fixed, at least when using the steam cleaning tool 100. For example, the handgrip 102 may also be put under different positions and/or angles γ with respect to the cleaning face 101, but be fixed during use. In an embodiment, the handgrip 102 is permanently fixed with respect to the cleaning face 101. For example, the handgrip 102 is integrated with the housing 104.

A relatively controlled and efficient use of a steam cleaning tool 100 is as follows. The steam cleaning tool 100 is held over a preferably relatively soft surface, for example a mattress, pillow or cushion, particularly a mattress. The cleaning face 101 is passed along said surface while steam 109 is dispensed by the tool 100 to said surface. While steam cleaning, the tool 100 can for example be moved in a way that is similar to applying stucco (i.e. plaster), which, using hindsight, seemed to be a convenient way for steam cleaning relatively soft and resistant surfaces such as mattresses, pillows and/or cushions. In an exemplary embodiment, the steam cleaning tool 100 therefore have design aspects similar to stucco tool (see for example FIG. 5). The cleaning face 101 is moved along said surface while the hand of the user holds the grip 102 relatively close to the cleaning face 101, for example directly above the cleaning face 101, preferably less than 15 cm from the cleaning face. At the same time, the hand is protected by the housing 104 or frame from heat and/or steam coming from the cleaning face 101 and/or nozzles 108. Among others, the fixed grip 102 aids the user in sliding the tool 100 over relatively soft surfaces, e.g. mattresses, that at the same time are resistant to flat humid surfaces, e.g. steam/mop heads.

With such a method and tool 100 especially hospital mattresses can be steamed cleaned in a convenient manner, i.e. the steam cleaning tool 100 can be slid over the mattress in a relatively smooth manner, as opposed to most other steam cleaning devices. In particular, the configuration of the handgrip 102 with respect to the cleaning face 101 provides for a convenient way of steam cleaning especially mattresses, as was confirmed by tests.

It shall be obvious that the invention is not limited in any way to the embodiments that are represented in the description and the drawings. Many variations and combinations are possible within the framework of the invention as outlined by the claims. Combinations of one or more aspects of the embodiments or combinations of different embodiments are possible within the framework of the invention. All comparable variations are understood to fall within the framework of the invention as outlined by the claims.

1. Mop head, provided with nozzles for dispensing fluid to a surface, a fluid guide for guiding fluid to the nozzles, and a mop face that is to be passed along the surface,
wherein the mop face comprises a mid face and opposite end faces, wherein at least one end face is arranged to extend at an angle with respect to the mid face, wherein the angle between the mid face and the at least one end face is larger than 180°.

2. Mop head according to claim 1, wherein the nozzles are provided along and/or in the mid face and the at least one end face.

3. Mop head according to claim 1, wherein the at least one end face is arranged to pivot with respect to the mid face about a pivoting axis and about an angle of approximately 90° such that the angle between said faces is approximately 270°.

4. Mop head according to claim 3, wherein a length of said fluid guide extends substantially parallel to said pivoting axis.

5. Mop head according to claim 1, wherein a hinge is arranged to pivot the mid face and said at least one end face with respect to each other.

6. Mop head according to claim 5, wherein the fluid guide extends through and/or along said hinge.

7. Mop head according to claim 1, wherein the mop head is provided with at least one connection element for cleaning material, which connection element is arranged to move along the mop face.

8. Mop head according to claim 7, wherein the at least one connection element is arranged to slide along the mop face.

9. Mop head according to claim 7, wherein the at least one connection element is arranged to move along the at least one end face.

10. Mop head according to claim 7, wherein the at least one connection element comprises Velcro.

11. Mop head according to claim 1, wherein the fluid guide comprises a flexible tube.

12. Mop with a mop head according to claim 1.

13. Method of mopping, wherein by means of a mop a first surface is mopped and a fluid is dispensed to said first surface, wherein at the same time a second surface is mopped, that is at an angle of larger than 180° with the first surface, and a fluid is dispensed to said second surface using the same mop.

14. Mop or method according claim 1, wherein the fluid comprises steam.

15. Mop head, preferably according to claim 1, provided with nozzles for dispensing fluid to a surface, a fluid guide for guiding fluid to the nozzles, and a mop face that is to be passed along the surface, wherein the nozzles are provided near and/or along edges of the mop face, and the mop head is provided with a handgrip that is connected near the mop face.
